(19) United States
(12) Patent Application Publication
(10) Pub. No.: US 2007/0252067 A1
(43) Pub. Date: Nov. 1, 2007

(54) Locking Latch for Telescoping Tripod

(76) Inventor: Wade Lee, Danville, CA (US)

Correspondence Address: ELLIOT B. ARONSON, 5001 HARBORD DRIVE, OAKLAND, CA, 94618, US

(21) Appl. No.: 11/739,790

(22) Filed: Apr. 25, 2007

Related U.S. Application Data
(60) Provisional application No. 60/745,726, filed on Apr. 26, 2006.

(51) Int. Cl. F16M 11/00

(52) U.S. Cl. 248/407

(57) ABSTRACT

A locking latch used with a telescoping support stand having one or more telescoping sections. Each section includes an inner tubular member with a plurality of positioning holes along its length and an outer tubular member with a latch hole positioned typically near the upper end of the outer member so as to line up in registration with the positioning holes as the inner tubular member is extended out of the outer tubular member. The outer member carries a latch mechanism comprising a latching arm that that has a locking disposition in which the arm extends through the outer member latch hole and one of the inner member positioning holes in registration with the outer member latch hole to hold the inner and outer tubular members in substantially fixed extension with respect to one another. A catch is provided in the form of a notch or a tang that is structured and arranged to prevent the latching arm from being moved out of the locking disposition when the weight of the inner tubular member bears down on the latching arm and to permit the latching arm to be moved out of the locking disposition when the inner tubular member is lifted with respect to the outer tubular member. In another embodiment a tang is provided that catches on a hole in the latching arm to define the locking disposition.

### BACKGROUND OF THE INVENTION

The present invention relates to portable telescoping tripods or similar support stands such as may be used for supporting worklights or the like.

Portable worklights are found in a variety of settings such as construction sites, industrial plants, automotive and auto body repair shops, artist and photographic studios, and around the home for do-it-yourself projects. An example of such a worklight is shown in U.S. Pat. No. 6,824,297 of Lee. These lights are often used with a separate upright stand with one or more extendable telescoping sections such as a telescoping tripod for adjusting the height of the worklight above the ground or work surface. In keeping with common usage, such extendable support structures may sometimes be referred to herein as “tripods,” and no limitation specifically to a three-legged structure is intended.

A number of releasable locking mechanisms are known for holding the telescoping sections of the tripod in their extended configuration and for permitting the user to release the sections so they may be slid back into their retracted configuration. The locking mechanisms can be problematic when the tripod is used with these worklights. The larger worklights may weigh around fifteen pounds or more and tend to be unwieldy when set atop an extended tripod, which is often moved around during use to reposition it as the job progresses. The locking mechanism has to hold the extended sections tightly to support the weight of the worklight under these conditions. For example, one common locking mechanism is a threaded twist collar that the user tightens around the junction between telescoping nested tubular sections to hold the sections in their extended configuration by friction. If the user does not tighten the collar sufficiently, the tripod can unexpectedly slip and collapse. In another simple such mechanism a pin is inserted through two aligned holes in the telescoping nested tubular sections to hold them in fixed position with respect to one another. While this arrangement avoids the problem of slippage due to insufficiently tightened collars, it is subject to abrupt and unexpected collapse for a different reason. It is the pin that holds the telescoping sections in place, and if the pin is simply withdrawn without the user also holding the upper member of the telescoping pair, the telescoping section will abruptly collapse. Thus, the pin mechanism is not normally used on tripods intended to support any substantial weight such as a dual-head halogen worklight. To guard against unintended collapse if the pin should be withdrawn without the user holding the upper section, one possible approach is to turn up the end of the pin slightly so that the turned-up pin end will catch on the inner tubular section preventing the pin from being withdrawn unless the user simultaneously pulls up on the inner tubular section raising it high enough so that the turned-up catch clears the top edge of the hole in the inner tubular section. This approach, while viable, is less than ideal due to manufacturability difficulties and performance drawbacks.

### SUMMARY OF THE INVENTION

It is an object of the present invention to provide a catch for a pin-type latching mechanism that is not only secure against unintended, careless and accidental collapse of the extended section under the action of the supported weight, but also is simple to manufacture with no significant addition to the cost of manufacture. It is also an object of the invention to provide a catch arrangement that gives the locking mechanism a comfortable feel to the user when in use.

Briefly, a locking latch according to the invention is used with a conventional telescoping support stand having one or more telescoping sections. Each section includes an inner tubular member in telescoping relation with an outer member so that the inner member can slide in and out of the outer member. The inner tubular member is formed with one or more positioning holes along its length, and the outer tubular member has a latch hole positioned typically near the upper end of the outer member so as to line up in registration with the positioning holes as the inner tubular member is extended out of the outer tubular member. The outer member carries a latch mechanism comprising a latching arm that that has a locking disposition in which the arm extends through the outer member latch hole and one of the inner member positioning holes in registration with the outer member latch hole to hold the inner and outer tubular members in substantially fixed extension with respect to one another. To provide the locking action of the invention, in one embodiment a retaining member in the form of a notch is formed at the inner end of the latching arm sized and positioned so that it will receive the upper edge of a positioning hole when the latching arm is in its locking disposition. When the weight of the inner tubular member caught in the notch bears down on the latching arm, the latching arm is locked in position and cannot be removed unless the inner tubular member is lifted up, out of the notch, in which case the user is holding the inner tubular member and it is safe to withdraw the latching arm.

In another embodiment the positioning hole is provided with a tang that fits into a hole at the inner end of the latching arm and serves to catch the locking arm in its locking disposition.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is an overall perspective view of an extendable support stand incorporating the invention with a worklight mounted thereon.

FIG. 2A is a cross-sectional view of a latching mechanism in its latching disposition.

FIG. 2B is a cross-sectional view of the latching mechanism of FIG. 2A with the latching arm freed to be removed from its latching disposition.

FIG. 3 is a perspective view of a release lever showing an embodiment of latching arm and retaining member.

FIG. 4 is a perspective view of the release lever of FIG. 3 mounted on an outer tubular member.

FIG. 5 is a perspective view of an alternative embodiment of latching arm and positioning hole with retaining member.

### DETAILED DESCRIPTION OF ILLUSTRATIVE EMBODIMENTS

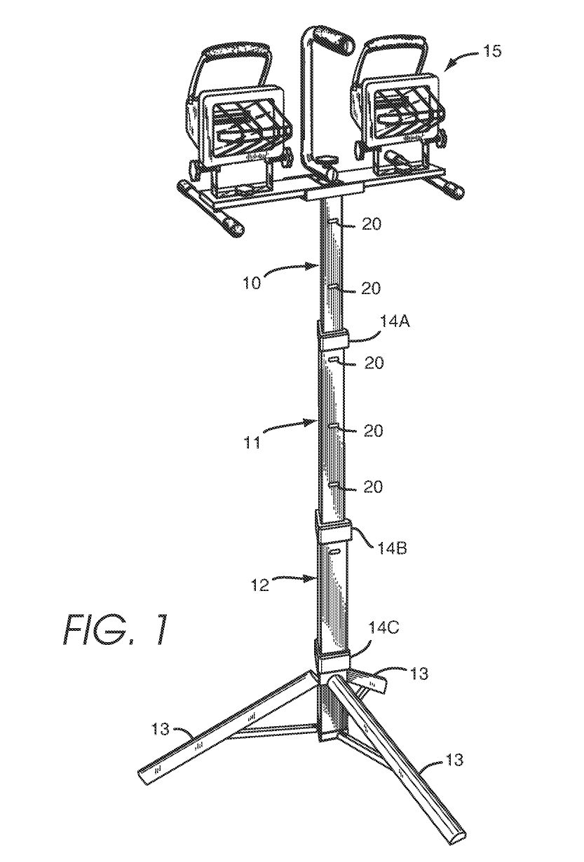

FIG. 1 shows an extendable support stand, commonly referred to as an extendable tripod, supporting a dual-head halogen worklight 10. The tripod includes an elongate base section 11 and two extendable elongate sections 12 and 13. The sections 11, 12, 13 are in telescoping relation with one another such that section 10 retracts into section 11, which retracts into base section 12. The sections 11 and 12 may be extended by variable amounts to adjust the height of the tripod. The tripod also includes a plurality of deployable legs 13 for supporting the tripod on the ground or other work surface. Between each pair of adjacent sections is a latching mechanism 14A and 14B for securely holding the extended sections in their extended disposition. The latching mechanism is releasable to permit the user to retract the tripod sections as desired. The tripod of FIG. 1 also includes a latching mechanism 14C that slides along the base section 12 and locks the legs 13 into a retracted position against the base section.

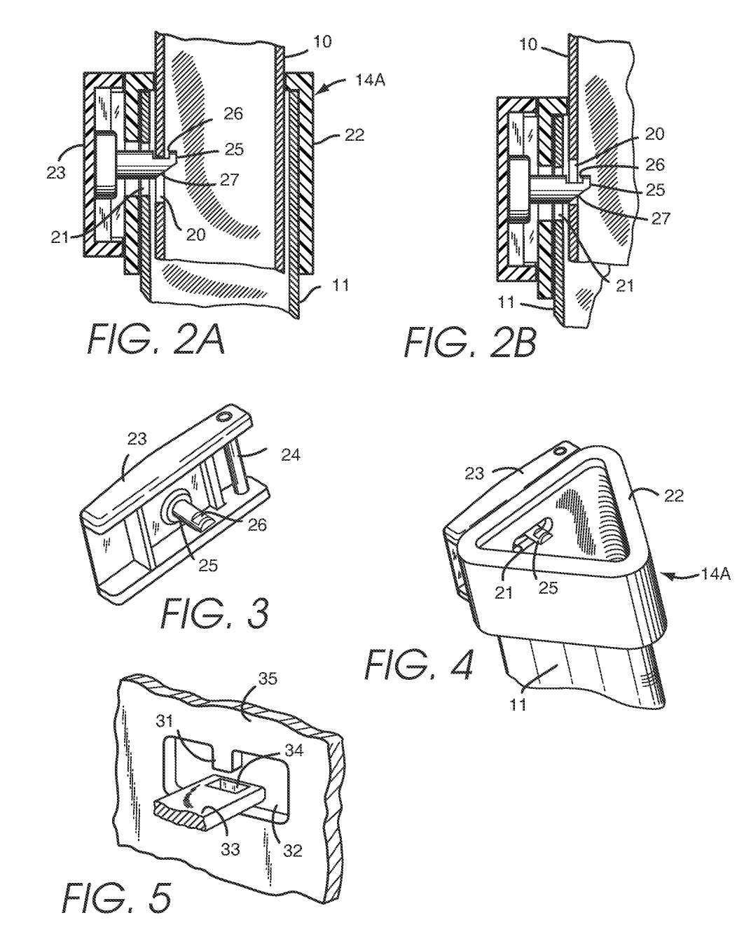

The latching mechanism 14A and 14B described hereinbelow is an improvement of a pin-type mechanism. FIG. 2A shows a cross-sectional view taken vertically through the tripod of FIG. 1 at latching mechanism 14A. Although FIG. 2A shows reference numerals indicating that it is the latching mechanism 14A, the same cross section applies equally well to latching mechanism 14B with the appropriate reference numerals substituted. The sections 10 and 11 of FIG. 1 have a plurality of positioning holes 20 disposed along their length for adjusting the height of the tripod. Outer section 11 has a latch hole 21 formed in it at its upper end (visible in FIGS. 2A and 2B), which is disposed so as to align in registration with positioning holes 20 in inner section 10 as the inner section is pulled out of outer section 11. To assure that the alignment of positioning holes 20 with latch hole 21 is maintained as the sections are repeatedly extended and retracted, the sections 10, 11, 12 of FIG. 1 take the form of tubular members that fit one within the other and that have a generally three-sided cross section so that the tubular members cannot rotate along their longitudinal axis with respect to one another. Other generally polygonal cross sections will also serve to maintain the alignment. The sections 10, 11, 12 may of course also be formed of cylindrical tubular members, but then additional indexing mechanism will be needed to maintain the alignment of holes. Appropriate indexing mechanisms are well known, for example, mating keys and keyways, and thus are discussed here in any detail.

A coupling 22 is attached to the upper end of outer tubular member 11. Coupling 22 includes a release lever 23 than that is hinged at one end at hinge pin 24 to the coupling 22. Lever 23 carries a latching arm 25, which in FIGS. 2A, 2B, 3 and 4 is in the form of a short cylindrical pin, although other shapes, such as a flat strip, could be used. In the locking disposition the latching arm 25 extends through latch hole 21 and positioning hole 20 lined up with the latching hole so that the upper edge of positioning hole 20 in inner tubular member 12 rests on the latching arm. When release lever 23 is rotated about hinge pin 24, latching arm 25 withdraws from the positioning hole and latch hole, and inner tubular member 10 is free to be retracted into or extended further out of outer member 11.

One way to prevent unintended removal of the latching arm is to turn up the inside end of the arm so that the turned-up end will catch on the inside of inner tubular member 12 if one merely attempts to pull on release lever 23. If positioning holes 20 are sufficiently large in the vertical dimension, then the user will have enough play to lift up the section 10 so that the turned-up end clears the upper edge of hole 20 as the arm is withdrawn from the inner and outer tubular sections 10 and 11. In this way the user is forced to grasp and hold the upper section 10 (or the worklight 15 atop section 10, if that is more convenient) as the pin is withdrawn. This prevents the upper section and its load from inadvertently and unexpectedly crashing down. When the user is not holding the section 10, which rests in its position under its own weight and the weight of the supported worklight load, the latch mechanism is locked in its latching disposition so that it cannot accidentally be released for example under the action of vibration or unintentionally released for example if a user or a curious or mischievous passerby should pull on the latch mechanism 14A without holding the section 10. A mere turned-up pin, however, is subject to drawbacks. As simple as the concept of a mere turned-up pin sounds, manufacture of the pin is too involved, which undesirably raises the cost. The pin must be bent and cut and/or hammered out and shaped in an appropriate manner. In addition to requiring extra manufacturing steps and putting up the cost, the turned-up pin construction generally results in manufacturing tolerances that are greater than desirable for a high-quality product. In addition, the turned-up pin is subject to the drawback that it presents too wide of an upward surface. When the height of the inner tubular section 10 is first being adjusted, the section may come to rest on the wide turned-up portion of the pin instead of on the pin shaft in front of the turned-up portion. Such a resting position defeats the locking action of the pin.

The present invention is directed to a catch mechanism that overcomes these drawbacks of the turned-up pin. As illustrated in the embodiment of FIGS. 2A, 2B, 3 and 4, the catch comprises a retaining member formed by a notch 26 at the inner end of latching arm 25. The notch is sized and positioned on latching arm 26 so that it will receive the upper edge of a positioning hole 20 when the latching arm is in its locking disposition. A first embodiment of latching arm catch is shown in FIGS. 2A, 2B, 3 and 4. FIG. 2A shows the latching arm in its locking disposition with the upper edge of tubular member 10 resting in notch 26. When an attempt is made to withdraw the latching arm, the distal face of the notch, that is, the face closest to the inner, distal end of the latching arm, engages the inner surface of inner tubular member 10, which prevents the latching arm from being withdrawn. The positioning holes 20, however, are formed with a sufficient vertical dimension and the latching arm has appropriate thickness that there is sufficient vertical play for the latching arm to be withdrawn once inner tubular member 10 is lifted slightly within the limits of the vertical play so that the upper edge of the positioning hole clears the notch. FIG. 2B shows inner tubular member 10 raised up to clear the way for the latching arm to be withdrawn. The notch construction is particularly desirable because of its ease of manufacture, as well as lower cost of manufacture, and because the notch can be cut with tighter tolerances on its precision. This leads to a better feel for the locking mechanism in use and, for tripods with more than one locking mechanism, greater uniformity of feel and performance for all the locking mechanisms on the tripod.

To assist further in unlatching the tripod, latching arm 25 is formed with a chamfer 27 on the bottom opposite notch 26. As the user pulls up slightly on the tripod mast, the lower edge of positioning hole 20 in the inner tubular member engages the chamfer 27 and urges the pin out of the hole. The user then only has to pull very gently, if at all, on release lever 23 to enable the inner tubular member to be slid freely up and down within the outer member.

FIG. 5 shows an alternative mechanism, in which a tang 31 extends down from the upper edge of positioning hole 32 to provide the retaining member. Latching arm 33 is formed with a catch hole 34 at its inner end that is sized and positioned to receive tang 31 when the latching arm is in its locking disposition. When the user lifts up on inner tubular member 35, tang 31 is raised out catch hole 34, thus freeing up the latching arm to be withdrawn.

In the illustrated embodiments the positioning holes have a generally rounded rectangular form with the long dimension of the rectangle extending horizontally. This extended horizontal form provides clearance for the latching arm to swing out as release lever 23 is rotated about hinge position 24. It is not necessary, however, that the latching arm and release lever 23 be hinged at the side as illustrated herein, and other implementations, hinged or not, for inserting and withdrawing the latching arm may be used.

The above descriptions and drawings are given to illustrate and provide examples of various aspects of the invention in various embodiments. It is not intended to limit the invention only to these examples and illustrations. Given the benefit of the above disclosure, those skilled in the art may be able to devise various modifications and alternate constructions that although differing from the examples disclosed herein nevertheless enjoy the benefits of the invention and fall within the scope of the invention, which is to be defined by the following claims. Any limitation in the claims expressly using the word “means” is intended to be interpreted as a “means plus function” limitation in accordance with Title 35, United States Code, Section 112, and any claim limitation not expressly using the word “means” is not intended to be so interpreted.

What is claimed is:

1. In a telescoping support stand structured to extend and retract vertically in normal usage, the support stand having one or more telescoping sections, wherein each such section comprises an inner tubular member in telescoping relation with an outer tubular member, the inner member having a plurality of positioning holes along its length and the outer member having a latch hole positioned on the outer member so as to line up in registration with the positioning holes on inner member as the inner member is extended out of the outer member, wherein the outer member carries a latch mechanism comprising a latching arm that has a locking disposition in which the arm extends through the outer member latch hole and one of the inner member positioning holes in registration with the outer member latch hole to hold the inner and outer tubular members in substantially fixed extension with respect to one another, and wherein the latch mechanism enables the latching arm to be moved into and out of the locking disposition for holding and releasing the inner and outer tubular members, the improvement characterized in that:
said latching arm is formed with a notch across the upper surface of said arm proximate the inner end of the arm formed and positioned to receive the upper edge of each of said positioning holes, thereby to prevent said latching arm from being withdrawn from said locking disposition when the weight of said inner member bears on said latching arm.

2. In a telescoping support stand structured to extend and retract vertically in normal usage, the support stand having one or more telescoping sections, wherein each such section comprises an inner tubular member in telescoping relation with an outer tubular member, the inner member having a plurality of positioning holes along its length and the outer member having a latch hole positioned on the outer member so as to line up in registration with the inner member positioning holes as the inner member is extended out of the outer member, wherein the outer member carries a latch mechanism comprising a latching arm that has a locking disposition in which the arm extends through the outer member latch hole and one of the inner member positioning holes in registration with the outer member latch hole to hold the inner and outer tubular members in substantially fixed extension with respect to one another, and wherein the latch mechanism enables the latching arm to be moved into and out of the locking disposition for holding and releasing the inner and outer tubular members, the improvement characterized in that:
wherein said positioning holes are formed with a downward extending tang at the upper edge of said positioning holes; and
wherein said latching arm is formed at its inner end to receive said tang, thereby to prevent said arm from being withdrawn from said locking disposition when the weight of said inner tubular member bears on said arm; and
wherein said positioning holes and said tang are sized to provide sufficient vertical play permitting said arm to be withdrawn from said locking disposition when said inner tubular member is lifted within the limits of said vertical play.
